(19) United States
(12) Patent Application Publication
(10) Pub. No.: US 2006/0162381 A1
(43) Pub. Date: Jul. 27, 2006

(54) Method of manufacturing tin oxide-based ceramic resistors & resistors obtained thereby

(75) Inventors: Rafal Pabich, Aurora, IL (US); Doreen Edwards, Almond, NY (US); Hamilton Black, Alfred Station, NY (US); Michael Stephen Ugorek, Albion, NY (US)

Correspondence Address: MCDERMOTT WILL & EMERY LLP, 600 13TH STREET, N.W., WASHINGTON, DC, 20005-3096, US

(73) Assignee: OHMITE HOLDINGS, LLC

(21) Appl. No.: 11/041,205

(22) Filed: Jan. 25, 2005

(51) Int. Cl. B32B 17/06; C03B 19/09

(52) U.S. Cl. 65/17.3; 428/426

(57) ABSTRACT

A method of manufacturing a tin oxide-based bulk ceramic resistor comprises steps of: (a) forming a first powder comprised of an antimony-doped tin oxide material; (b) providing a second powder comprised of a vitreous glass frit; (c) forming a third, mixed powder by mixing together preselected amounts of the first and second powders; (d) forming the third, mixed powder into a solid body of preselected shape and dimensions; and (e) treating the body at a preselected elevated temperature for a preselected interval. Also disclosed are antimony-doped tin oxide-based bulk ceramic resistors.

### FIELD OF THE INVENTION

The present invention relates to methods of manufacturing tin oxide-based ceramic resistors and ceramic resistors made thereby. More particularly, the present invention relates to antimony (Sb)-doped tin oxide (SnO₂) ceramic resistors and methods for manufacturing same. The invention finds particular use in the manufacture of resistor devices for use in surge protection devices.

### BACKGROUND OF THE INVENTION

Electrical resistors can generally be classified based upon the type of resistive material utilized for the resistive element, as follows:

metallic; e.g., wire wound or metal element resistors

thick film; e.g., resistive ink or paste deposited on a suitable substrate, such as of a ceramic material

thin film; e.g., a thin resistive film, such as of nichrome (Ni—Cr) or tantalum nitride (TaN), deposited on a suitable substrate, e.g., a ceramic material

bulk ceramic; resistive material in a body of ceramic material, wherein the entire body of ceramic conducts electricity and is doped with various non-metallic and metallic materials and fired at an elevated temperature.

The present invention is concerned with the last-mentioned resistor type, i.e., bulk ceramic resistors, and methods of manufacturing same. More specifically, the present invention is concerned with tin oxide (SnO₂)-based ceramic resistors and methods of manufacturing same.

Bulk ceramic resistors which utilize a vitreous resistor material are known, in which the resistor material comprises a mixture of a glass frit and finely divided particles of an electrically conductive material. Such resistors typically are formed by a process wherein a mixture of powdered glass frit and electrically conductive particles, e.g., SnO₂ particles, is fired at an elevated temperature to form a vitreous glass matrix with embedded conductive particles.

In view of the wide range of required resistance values for resistors utilized in various applications, it is desirable to have vitreous glass resistor materials with a respective wide range of resistance values facilitating manufacture of bulk ceramic resistors over that wide range of required resistance values. However, problems have arisen with regard to the formation of vitreous glass resistor materials which provide a requisite high resistivity and are relatively stable with respect to changes in temperature, i.e., with relatively low temperature coefficient of resistance (TCR). In this regard, resistor materials which provide both a wide range of resistivities and low TCR's generally utilize noble metals as the conductive particles and therefore are relatively expensive.

Tin oxide (SnO₂) has been utilized as a resistor material, e.g., in resistors wherein an enamel coating of a vitreous glass SnO₂-based resistor material is formed on a ceramic substrate, as for example, disclosed in Wahlers et al. U.S. Pat. No. 4,397,915. However, as also disclosed therein, SnO₂-based resistor films are not especially stable and exhibit highly negative TCR values. One approach for mitigating the aforementioned deficiencies of SnO₂-based resistive films involves doping of the SnO₂ with metals, e.g., antimony (Sb). Disadvantageously, however, this approach results in resistor materials with very high negative TCR values.

In view of the foregoing, and inasmuch as controlled addition of Sb to SnO₂, e.g., in the form of Sb₂O₃ or Sb₂O₅, is expected to be advantageous in facilitating manufacture of SnO₂-based bulk ceramic resistors of predetermined resistance values, an improved process for manufacturing Sb-doped SnO₂-based bulk ceramic resistors with a wide but controllable range of resistance values and acceptably low TCR values is considered desirable and necessary for further use of such resistive components in a wide variety of applications, including, but not limited to, surge protection devices.

### DISCLOSURE OF THE INVENTION

An advantage of the present invention is improved methods of manufacturing tin oxide-based bulk ceramic resistors.

Another advantage of the present invention is improved tin oxide-based bulk ceramic resistors.

Additional advantages and other features of the present invention will be set forth in the description which follows and in part will become apparent to those skilled in the art upon examination of the following or may be learned from the practice of the present disclosure. The advantages of the present invention may be realized and obtained as particularly pointed out in the appended claims.

According to an aspect of the present invention, the foregoing and other advantages are obtained in part by a method of manufacturing a tin oxide-based bulk ceramic resistor, comprising steps of:

(a) forming a first powder comprised of an antimony-doped tin oxide material;

(b) providing a second powder comprised of a vitreous glass frit;

(c) forming a third, mixed powder by mixing together preselected amounts of the first and second powders;

(d) forming the third, mixed powder into a solid body of preselected shape and dimensions; and

(e) treating the body at a preselected elevated temperature for a preselected interval.

In accordance with embodiments of the present invention, step (a) comprises forming the first powder by a process comprising mixing together preselected amounts of a tin oxide powder and an antimony oxide powder and treating the resultant mixture at a preselected elevated temperature for a preselected interval, the process comprising dry ball milling the preselected amounts of tin oxide and antimony oxide powders.

According to certain preferred embodiments of the invention, step (a) comprises mixing SnO₂ and Sb₂O₃ powders in about 95:5 ratio by weight; whereas, according to certain other embodiments of the invention, step (a) comprises mixing SnO₂ and Sb₂O₅ powders in about 94.5:5.5 ratio by weight.

Preferably, step (a) comprises heating the resultant mixture of SnO₂ and Sb₂O₃ powders at a temperature of about 1,100° C. for about 2 hrs.

According to preferred embodiments of the invention, step (b) comprises providing the second powder as a vitreous borosilicate glass frit comprising SiO₂, B₂O₃, BaO, and Al₂O₃ and dry ball milling the glass frit for an interval sufficient to enable the resultant second powder to pass through a 35 mesh screen prior to use in step (c); and step (c) comprises forming the third, mixed powder by steps including wet ball milling a mixture comprised of preselected volumes of the first and second powders to form a slurry, drying the slurry to remove the liquid vehicle therefrom and form a cake, and crushing and screening the cake. Preferably, step (c) comprises wet balling the mixture of first and second powders in water to form an aqueous slurry, drying the slurry at 70° C. for an interval sufficient to evaporate the water and form the cake, and crushing and screening the cake to form the third, mixed powder with a particle size <425 μm.

In accordance with embodiments of the present invention, step (d) comprises forming the third, mixed powder into a flat disk or cylindrical pellet of the preselected dimensions, e.g., by uniaxially pressing the third, mixed powder in a die or by extruding the third, mixed powder. In the latter instance, step (d) may optionally further comprise incorporating at least one binder and/or plasticizer in the third, mixed powder.

According to preferred embodiments of the invention, step (e) comprises sintering the thus-formed body at a temperature in the range from about 950 to about 1350° C. for an interval ranging from about 30 to about 60 min.; and the method further comprises a step of:

(f) forming at least a pair of electrical contacts to the body.

Preferred embodiments of the invention include those wherein step (c) comprises mixing together preselected amounts of the first and second powders to form a resistor having a resistance in the range from about 3 Ω to about 50 kΩ and a temperature coefficient of resistance (TCR) in the range from about −450 to about −4,200 ppm.

Another aspect of the present invention are improved antimony-doped, tin oxide-based bulk ceramic resistors manufactured according to the aforementioned methods.

Yet another aspect of the present invention is improved bulk ceramic resistors comprising a body of an antimony-doped tin oxide material dispersed in a vitreous glass matrix.

Preferably, the body is formed by sintering a mixture of antimony-doped tin oxide and vitreous glass powders, wherein the antimony-doped tin oxide powder comprises the product of firing a mixture of SnO₂ and Sb₂O₃ or Sb₂O₅ powders and the sintered glass matrix comprises a vitreous borosilicate glass. According to certain preferred embodiments of the invention, the mixture comprises SnO₂ and Sb₂O₃ powders mixed in a ratio of about 95:5 by weight; whereas, according to certain other embodiments of the invention, the mixture comprises SnO₂ and Sb₂O₅ powders mixed in a ratio of about 94.5:5.5 by weight.

According to embodiments of the invention, the antimony-doped, tin oxide-based bulk ceramic resistors have a resistance in the range from about 3 Ω to about 50 kΩ, a temperature coefficient of resistance (TCR) in the range from about −450 to about −4,200 ppm, and include at least a pair of electrical contacts (e.g., comprising silver (Ag)) affixed to the resistor body.

Additional advantages and aspects of the invention will become readily apparent to those skilled in the art from the following detailed description, wherein embodiments of the present disclosure are shown and described, simply by way of illustration of the best mode contemplated for practicing the present invention. As will be described, the invention is capable of other and different embodiments, and its several details are susceptible of modification in various obvious respects, all without departing from the spirit of the invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, wherein:

FIG. 1 is a schematic process flow chart of an illustrative, but non-limitative embodiment of the invention;

FIG. 2 is a graph for illustrating the variation of bulk density and shrinkage of SnO₂/glass compacts as a function of the firing temperature;

FIG. 3 is a plot of conductivity vs. corrected vol. % SnO₂ of SnO₂/glass compacts;

FIG. 4 is a graph illustrating the variation of electrical conductivity of the compacted composite pellets as a function of sintering temperature; and

FIG. 5 is a graph illustrating variations in resistivity of the Sb-doped SnO₂/glass composites made with Frit 2 as a function of vol. % SnO₂ (as prepared) and firing temperature.

### DESCRIPTION OF INVENTION

The present invention addresses and effectively solves, or at least mitigates, the above-described problems and/or difficulties associated with the manufacture of tin oxide-based bulk ceramic resistors, and is based upon development by the inventors of a reliable, cost-effective process (schematically shown in FIG. 1 in flow diagram form for an illustrative, but non-limitative embodiment of the invention) facilitating formation of Sb-doped SnO₂-based bulk ceramic materials. Briefly stated, Sb-doped SnO₂-based ceramic resistive material is formed according to the following sequence of steps constituting the inventive methodology: (1) a mixture comprised of preselected amounts of SnO₂ and Sb₂O₃ (or Sb₂O₅) powders is fired at an elevated temperature to form an Sb-doped SnO₂ powder; (2) the latter is mixed with a powdered vitreous glass frit in preselected proportions; (3) the mixture of Sb-doped SnO₂ and vitreous glass powders is wet ball milled to form a slurry; (4) a cake is formed from the slurry and broken up to form a powder comprising the Sb-doped SnO₂ and the vitreous glass frit; (5) the resultant powder is formed into a bulk body of preselected size and shape; and (6) the bulk body is sintered at a preselected elevated temperature for a preselected interval. Subsequent processing to form resistor devices includes formation of ohmic contacts to the body of resistive material, attachment of lead wires, and encapsulation in a suitable encapsulant material.

More specifically, a series of experiments were performed by the inventors, wherein 100 gm. (total) of SnO₂ and Sb₂O₃ powders were weighed out in a 95:5 ratio by weight. Reaction between the SnO₂ and Sb₂O₃ was accomplished by placing one-half of the SnO₂ powder in the bottom of an alumina (Al₂O₃) crucible, overlaying the SnO₂ with the Sb₂O₃ powder, and covering the Sb₂O₃ with the other half of the SnO₂ powder. The crucible was covered and the SnO₂/Sb₂O₃/SnO₂ charge fired in air at 1,100° C. for 2 hrs.

The compositions of the vitreous borosilicate glass frits 1 and 2 utilized in this study are summarized in Table I below. Each frit was dry ball-milled and passed through a 35 mesh screen prior to use.

TABLE I

| Component | Frit 1 (wt %) | Frit 2 (wt %) |
|---|---|---|
| SiO₂ | 30 | 30 |
| B₂O₃ | 20 | 20 |
| BaO | 30 | 46 |
| ZnO | 15 | 0 |
| Al₂O₃ | 5 | 4 |
| Total | 100 | 100 |

The Sb-doped SnO₂ powder was mixed with the glass frits to form 20 gm. batches with preselected glass/SnO₂ volume ratios. The following resistor compositions are reported as a volume/volume ratio. The corresponding mass fraction (MF) of each component is calculated using the density of the doped SnO₂ powder and the densities of the glass frit powders as follows:
MF_{SnO2}=ρ_{SnO2}ƒ_{SnO2}/ρ_{SnO2}ƒ_{SnO2}+ρ_{frit}ƒ_{frit}
MF_{frit}=ρ_{frit}ƒ_{frit}/ρ_{SnO2}ƒ_{SnO2}+ρ_{frit}ƒ_{frit}
where ρ is the density and ƒ is the desired volume fraction of the two phases.

The SnO₂/glass frit mixture was then wet ball-milled (with 10 mm φ ZrO₂ media) for 4 hrs. at (ω=80 rpm in a 250 ml polypropylene container. The amount of H₂O, ZrO₂ media, and charge in the ball mill jar was sufficient to fill half the volume thereof. Typically 50 gm. of powder was added to the jar, along with 350-380 gm. ZrO₂ media and sufficient H₂O to cover the media. For larger amounts of powder, additional H₂O was added to reduce the viscosity of the slurry.

The milled slurry was drained into a glass dish and the remaining media rinsed and drained repeatedly with distilled H₂O until the washings ran clear. After drying the slurry and washings overnight at 70° C., the caked powder (˜5 mm thick) was broken up, crushed, and screened to 35 M (<425 μm).

½ in. pellets were uniaxially pressed from the resultant powder in steel dies at 170 MPa using stearic acid dissolved in acetone as a die lubricant. The green strength of the pellet was sufficient for subsequent handling/processing (use of binders, plasticizers, etc., and lower pressures may be considered for production-scale processing).

The pressed pellets were then fired at temperatures in the range from about 700 to about 1,350° C. During firing, the pellets were ramped up at ˜10° C./min. to the desired final temperature and held at that temperature for about 30 to about 60 min. It was micrographically observed that the firing temperature affects the density and microstructure of the sintered Sb-doped SnO₂/glass frit resistor composites.

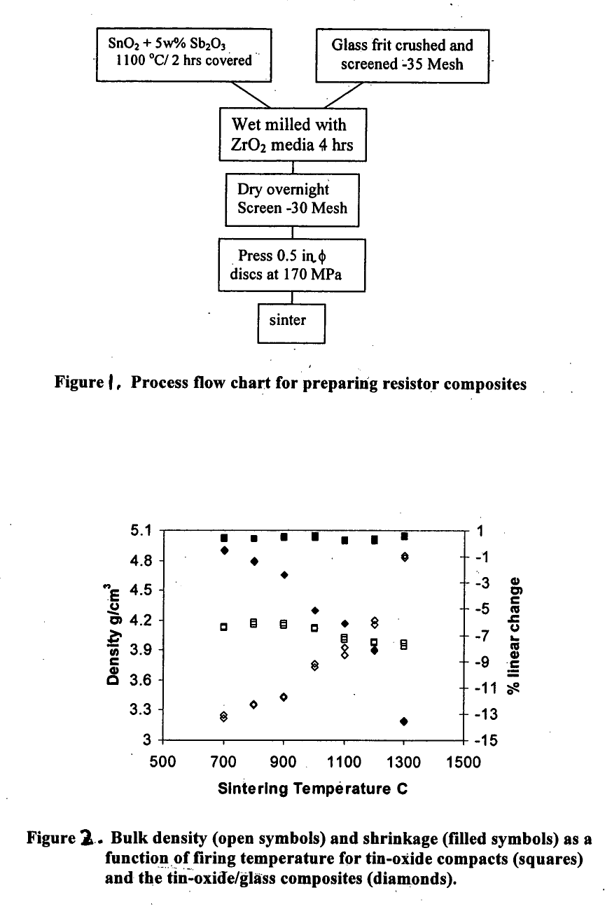

Referring to FIG. 2, shown therein is a graph for illustrating the variation of bulk density and shrinkage as a function of the firing temperature. As may be seen from the graph, the density of unfritted, compacted, Sb-doped SnO₂ pellets varies from about 53 to about 56% of the theoretical density (7.4 gm/cm³); and the decrease in density at firing temperatures >900° C. is attributed to the loss of antimony oxide. By contrast, the density of the Sb-doped SnO₂/glass frit composite pellets increased with firing temperature from about 59 to about 89% of the theoretical density (5.43 gm/cm³), with linear shrinkage approaching about 15%.

Micrographic studies of the resultant fired, glass-bonded compacted pellets indicated that as the firing temperature increases, the porosity decreases, in agreement with the data of FIG. 2. development of the glass matrix phase occurs as follows: At a firing temperature of 700° C., the glass appears to be melted, but agglomerates of SnO₂ are apparent. At higher firing temperatures, the SnO₂ particles are distributed throughout the glass phase matrix and conduction pathways are visible. At a firing temperature of 1,200° C., some large particles (i.e., ˜3-4 μm) of SnO₂ are observed, along with a concomitant oncrease of large glass matrix areas. Based upon these observations, it is considered that increased electrical conductivity will be obtained at higher firing temperatures, provided that significant vaporization of the conductive metal oxides does not occur.

Another series of compacted Sb-doped SnO₂/glass frit composite pellets were prepared using SnO₂ powders from Noah Technologies (San Antonio, Tex.) and Reade Co. (Providence, R.I.), Sb₂O₃ powder from Alfa Aesar (Ward Hill, Mass.), and the borosilicate glass frits 1 and 2 described above. The composite compacted pellets were prepared with glass frit/SnO₂ volume ratios of 70/30, 60/40, 50/50, 40/60, and 30/70 utilizing the process described supra. The following sintering conditions were utilized as the variable in this study: 1,350° C./60 min., 1,150° C./30 min., and 950° C./60 min.

Table II summarizes the densities and percent shrinkages of the composite pellets, wherein density ρ was measured by the Archimedes method and shrinkage S calculated as % decrease in pellet diameter. The composites with higher glass content reacted with the Al₂O₃ setter utilized in the study and could not be characterized; hence data for these samples are not presented in Table II. At sintering temperatures of 1,150 and 1,350° C., the samples with up to 50 vol. % glass frit could be processed without reacting with the setter; by contrast, at 950° C., samples with up to 60 vol. % glass frit could be processed.

TABLE II

| | Tin | | Glass/tin-oxide | Density | % of Theo. | |
|---|---|---|---|---|---|---|
| Frit | Oxide | Firing conditions | V % | g/cm³ | Density | % Shrinkage |
| Frit 1 | Noah | 950° C./60 min | 30/70 | 3.58 | 58.2 | 0.4 |
| | | | 40/60 | 3.48 | 60.6 | 0.6 |
| | | | 50/50 | 3.36 | 63.2 | 1.4 |
| | | | 60/40 | 3.78 | 77.2 | — |
| | | 1150° C./30 min | 30/70 | 4.01 | 65.2 | 3.7 |
| | | | 40/60 | 3.98 | 69.4 | 3.9 |
| | | | 50/50 | 4.02 | 75.5 | 5.4 |
| | | 1350° C./60 min | 30/70 | 5.45 | 88.6 | 13.5 |
| | | | 40/60 | 5.22 | 91.6 | 14.3 |
| | | | 50/50 | 5.03 | 94.7 | 13.8 |
| | Reade | 950° C./60 min | 30/70 | 3.60 | 58.5 | 0.1 |
| | | | 40/60 | 3.53 | 61.5 | 0.9 |
| | | | 50/50 | 3.38 | 63.5 | 1.4 |
| | | | 60/40 | 3.74 | 76.4 | — |
| | | 1150° C./30 min | 30/70 | 4.02 | 65.4 | 3.1 |
| | | | 40/60 | 3.96 | 68.9 | 3.4 |
| | | | 50/50 | 3.98 | 74.8 | 5.4 |
| | | 1350° C./60 min | 30/70 | 5.42 | 88.0 | 14.1 |
| | | | 40/60 | 5.20 | 90.7 | 13.4 |
| Frit 2 | Noah | 950° C./60 min | 30/70 | 3.58 | 57.6 | 0.6 |
| | | | 40/60 | 3.54 | 61.0 | 0.8 |
| | | | 50/50 | 3.52 | 65.2 | 1.8 |
| | | | 60/40 | 4.06 | 81.4 | — |
| | | 1150° C./30 min | 30/70 | 3.81 | 61.4 | 2.4 |
| | | | 40/60 | 3.82 | 65.9 | 3.1 |
| | | | 50/50 | 4.12 | 76.5 | 6.4 |
| | | 1350° C./60 min | 30/70 | 4.87 | 78.6 | 10.0 |
| | | | 40/60 | 4.96 | 85.6 | 11.0 |
| | | | 50/50 | 4.75 | 88.1 | 11.8 |
| | Reade | 950° C./60 min | 30/70 | 3.76 | 60.7 | 0.5 |
| | | | 40/60 | 3.67 | 63.3 | 0.9 |
| | | | 50/50 | 3.57 | 66.3 | 1.4 |
| | | | 60/40 | 3.96 | 79.4 | — |
| | | 1150° C./30 min | 30/70 | 4.10 | 66.2 | 2.2 |
| | | | 40/60 | 3.98 | 68.6 | 2.4 |
| | | | 50/50 | 3.93 | 72.8 | 3.5 |
| | | 1350° C./60 min | 30/70 | 4.98 | 80.3 | 8.2 |
| | | | 40/60 | 4.76 | 82.2 | 7.4 |
| | | | 50/50 | 4.63 | 85.8 | 8.4 |

Several expected trends are evident from the data of Table II. For example, at a given sintering condition, the density (measured as % of theoretical density) and shrinkage generally increase with increasing glass frit content. (An exception is noted with samples processed at 1,350° C., where shrinkage did not exhibit any specific trends with glass frit content). Micrographs of the fired compacted pellets indicated differences in microstructure with glass frit contact. By way of example, Frit 1/Noah pellets with lower glass contents (i.e., 30/70 and 40/60 glass frit/SnO₂) fired at 1,150° C. showed large, irregular pores (>5 μm) and very little SnO₂ grain growth occurred.

For a given glass frit/SnO₂ composition, the density and shrinkage increased with increased sintering temperature. Micrographic studies indicated that Frit 1/Noah samples sintered at 1,350° C. were less porous than similar composition Frit 1/Noah samples sintered at 1,150° C. However, some grain SnO2 grain growth up to ˜4-5 μm was observed. Also, while the data in Table I indicate that the Noah Technologies SnO₂ powder yielded composite pellets with a larger range of densities than those made with the Reade Co. powder (i.e., 57.6-94.7% of theoretical vs. 58.5-90.4%), a comparison of the microstructures showed no significant differences.

At the highest firing temperature (1,350° C.), higher densities were achieved with glass Frit 1 than with glass Frit 2 (no ZnO, greater BaO content than Frit 1). In addition, compared to the composites prepared with Frit 1, the composites prepared with Frit 2 exhibited less SnO₂ grain growth. While not desirous of being bound by any particular theory, one explanation offered for the difference is that the SnO₂ has a greater solubility in Frit 1, which in turn may promote grain growth by a solution re-precipitation mechanism. However, elemental analyses of the glass phases in the composites, as determined by energy dispersive X-ray spectra (EDS) of the glassy areas in the fired glass frit/Sb-doped SnO₂ compacted composite pellets prepared with Frits 1 and 2 did not support this explanation.

Referring now to Table III, summarized therein are measurements of the conductivity (S/cm), resistivity (Ω-cm), and temperature coefficient of resistance (TCR) (ppm) of the fired glass frit/Sb-doped SnO₂ composite pellets of Table I provided with Ag paste electrodes.

TABLE III

| | Tin | Firing | Glass/tin-oxide | Conductivity | Resistivity | TCR |
|---|---|---|---|---|---|---|
| Frit | Oxide | conditions | V % | (S/cm) | (Ohm-cm) | (ppm) |
| Frit 1 | Noah | 950° C./60 min | 30/70 | 0.013 | 77 | −2839 |
| | | | 40/60 | 0.013 | 77 | −2787 |
| | | | 50/50 | 0.0072 | 139 | −2975 |
| | | | 60/40 | 0.035 | 29 | −1691 |
| | | 1150° C./30 min | 30/70 | 1.4 | 0.71 | −738 |
| | | | 40/60 | 1.1 | 0.91 | −736 |
| | | | 50/50 | 0.83 | 1.2 | −749 |
| | | 1350° C./60 min | 30/70 | 19 | 0.053 | −466 |
| | | | 40/60 | 12 | 0.08 | −504 |
| | | | 50/50 | 6.7 | 0.15 | −573 |
| | Reade | 950° C./60 min | 30/70 | 0.0346 | 29 | −2100 |
| | | | 40/60 | 0.0317 | 32 | −670 |
| | | | 50/50 | 0.00787 | 127 | −2975 |
| | | | 60/40 | 0.0388 | 26 | −1691 |
| | | 1150° C./30 min | 30/70 | 0.27 | 3.7 | −2022 |
| | | | 40/60 | 0.23 | 4.3 | −2150 |
| | | | 50/50 | 0.19 | 5.3 | −1962 |
| | | 1350° C./60 min | 30/70 | 13 | 0.08 | −548 |
| | | | 40/60 | 11 | 0.09 | −782 |
| Frit 2 | Noah | 950° C./60 min | 30/70 | 0.055 | 18 | −1736 |
| | | | 40/60 | 0.0054 | 185 | −3063 |
| | | | 50/50 | 0.00027 | 3704 | −4207 |
| | | | 60/40 | 0.00088 | 1136 | −1791 |
| | | 1150° C./30 min | 30/70 | 0.038 | 26 | −1884 |
| | | | 40/60 | 0.023 | 43 | −2144 |
| | | | 50/50 | 0.037 | 27 | −1879 |
| | | 1350° C./60 min | 30/70 | 1.1 | 0.91 | −1074 |
| | | | 40/60 | 2.4 | 0.42 | −590 |
| | | | 50/50 | 0.88 | 1.1 | −449 |
| | Reade | 950° C./60 min | 30/70 | 0.07 | 14 | −1403 |
| | | | 40/60 | 0.044 | 23 | −1579 |
| | | | 50/50 | 0.0043 | 233 | −2465 |
| | | | 60/40 | 0.0003 | 3333 | −3408 |
| | | 1150° C./30 min | 30/70 | 0.13 | 7.7 | −1583 |
| | | | 40/60 | 0.084 | 11.9 | −1407 |
| | | | 50/50 | 0.06 | 16.7 | −1306 |
| | | 1350° C./60 min | 30/70 | 1.8 | 0.56 | −592 |
| | | | 40/60 | 0.65 | 1.5 | −598 |
| | | | 50/50 | 0.67 | 1.5 | −656 |

As is evident from the data of Table III, the conductivities of the fired composite pellets ranged over 5 orders of magnitude from a low of ˜2.7×10⁻⁴ S/cm to ˜19 S/cm. In terms of resistivity, the range can be expressed as from ˜3,700 to ˜0.053 Ω-cm. The TCR ranged from ˜−449 to ˜−4,207 ppm.

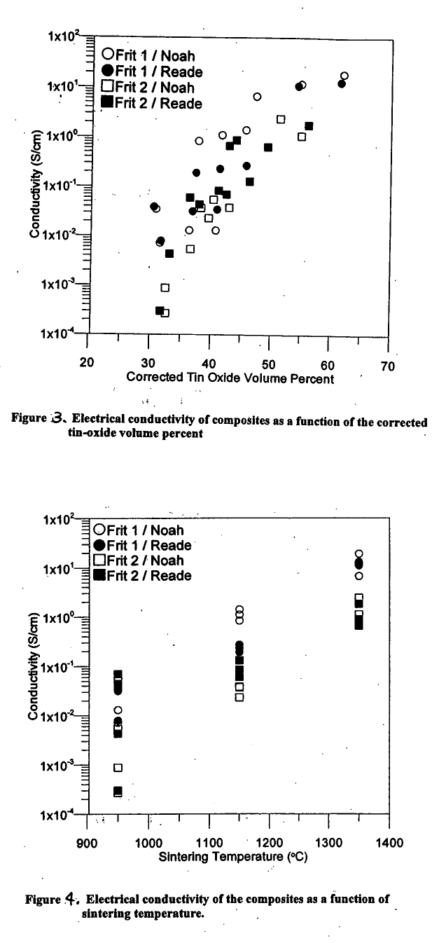

In general, the conductivity increased with increased SnO₂ content for a given firing schedule, with a few exceptions to this generality noted in Table III. In some instances, the unexpected trend may be attributed to differences in the porosity of samples prepared with different amounts of the glass phase. Referring to FIG. 3, in a plot of conductivity vs. corrected vol. % SnO₂ (calculated as the formulated SnO₂ volume fraction multiplied by the % theoretical density), all of the data points fall within a broad band. For samples with similar values of corrected vol. %. For samples with similar values of corrected vol. % SnO₂, samples prepared with Frit 1 (shown by circles in the figure) were generally more conductive than those prepared with Frit 2 (shown by squares in the figure), although there is considerable scatter in the data.

For a given resistor composition, conductivity increased with increased firing temperature, due to decreasing porosity and increasing degree of continuity of the SnO₂ particles in the compacted composite pellets. Referring to FIG. 4, which is a graph illustrating the variation of electrical conductivity of the compacted composite pellets as a function of sintering temperature, it is seen that samples prepared with Frit 1 (shown by circles in the figure) tend to have higher conductivity than those prepared with Frit 2 (shown by squares in the figure), especially at the higher sintering temperatures.

Sintered glass/Sb-doped SnO₂ compacts fabricated with SnO₂ powders obtained from different sources (i.e., Noah Technologies and Reade Co.) did not exhibit significant differences in conductivity. However, the data of FIGS. 2 and 3 suggest that samples prepared with the Noah Technologies SnO₂ powder had a wider conductivity range than those prepared with the Reade Co. SnO₂ powder (note in this regard that the compacts prepared with the Noah Technologies powder exhibited a wider range of densities than compacts prepared with the Reade Co. powder.

The composition of the glass frit is seen to exert a notable effect on the obtained conductivities, primarily due to the different types of microstructures that developed in each case. In this regard, it is noted that Frit 1/SnO₂ powder mixtures underwent considerable grain growth upon sintering, whereas Frit 2/SnO₂ mixtures did not.

The resistance values obtainable with the sintered composite materials according to the present invention depend upon the dimensions of the resistors. Table III summarizes the resistance values of resistors that can be obtained using the same dimensions as for OX/OY series resistors marketed by Ohmite Manufacturing, Rolling Meadow, Ill. (assignee of the present invention). The lower limit of this range is comparable to that reported for the OX/OY series, but the upper limit is lower.

TABLE IV

| | OX Dimensions | OY Dimensions |
|---|---|---|
| Resistor Designation/ | | |
| Dimensions | | |
| Length (cm) | 1.9 | 2.25 |
| Diameter (cm) | 0.65 | 0.8 |
| Length/area (cm⁻¹) | 5.73 | 4.48 |

| | |
|---|---|
| Frit/Powder System | Resistance Range, Ω |

| | | |
|---|---|---|
| Frit 1/Noah | 0.30-800 | 0.24-620 |
| Frit 1/Reade | 0.44-730 | 0.34-570 |
| Frit 2/Noah | 2.4-21K | 1.9-17K |
| Frit 2/Reade | 3.2-19K | 2.5-15K |

Resistance values of resistors fabricated according to the instant invention can be manipulated somewhat by altering the dimensions of the resistor. For example, using the dimensions for Ohmite Manufacturing's MX series of resistors, the resistance ranges of the glass frit/Sb-doped SnO₂ systems according to the invention can be extended to higher values, as shown in Table V, in which instance an upper resistance value of ˜50 KΩ is achievable.

TABLE V

| | MXR | MX1 | MX2 | MX3 | MX5 |
|---|---|---|---|---|---|
| Resistor | | | | | |
| Designation/ | | | | | |
| Dimensions | | | | | |
| Length (cm) | 0.75 | 1 | 1.2 | 1.6 | 2.5 |
| Diameter | 0.25 | 0.4 | 0.5 | 0.55 | 0.8 |
| (cm) | | | | | |
| Length/area | 15.28 | 7.96 | 6.11 | 6.73 | 4.97 |
| (cm⁻¹) | | | | | |
| Frit/Powder | | | | | |
| System | Range of Resistances (Ohm) | | | | |
| Frit 1/Noah | 0.80-2100 | 0.42-1100 | 0.32-850 | 0.35-940 | 0.25-690 |
| Frit 1/Reade | 1.2-1900 | 0.61-1K | 0.47-780 | 0.52-860 | 0.38-630 |
| Frit 2/Noah | 6.4-57K | 3.3-29K | 2.6-23K | 2.8-25K | 2.1-18K |
| Frit 2/Reade | 8.5-51K | 4.4-27K | 3.4-20K | 3.7-22K | 2.8-17K |

In summary, the present invention demonstrates that Sb-doped SnO₂/glass matrix ceramic resistors may be readily fabricated in a wide range of resistivities by means of standard ceramic materials processing techniques. Studies of resistors made from 4 different materials systems indicate that resistivities spanning 4 orders of magnitude, from ˜5.3×10⁻² to ˜3.7×10³ Ω-cm are possible, with TCR's ranging from ˜−450 to ˜4,200 ppm.

The following considerations with respect to the commercial manufacture of Sb-doped SnO₂/glass matrix ceramic resistors are noted:

the source of the SnO₂ powder utilized for forming the composite compacts is not critical for the practice of the invention; however, powders for use according to the inventive methodology should possess similar mean particle size, particle distribution, and purity level;

doping of the SnO₂ powder with Sb is critical for obtaining low TCR values. The source of the Sb₂O₃ powder is not considered critical for practice of the invention; powder with particle size >˜5 μm is recommended. Further, it is expected that Sb₂O₅ powder (derived from oxidation of Sb₂O₃) will provide similar results as Sb₂O₃ powder, because the processing conditions (e.g., temperature and O₂ partial pressure) dictate which antimony oxidation state, i.e., Sb³⁺ or Sb⁵⁺ is present in the final, sintered product. In the event Sb₂O₅ powder is utilized rather than Sb₂O₃ powder, it should be added to the SnO₂ powder at a level of ˜5.5 wt. % instead of ˜5 wt. % in order to account for the difference in molecular weights of the Sb₂O₃ and Sb₂O₅;

in the previous description, the Sb₂O₃ powder was placed between 2 layers of SnO₂ powder and heated to a preselected temperature. However, when processing larger quantities of materials, thorough mixing of the Sb₂O₃ and SnO₂ powders before heating (as by dry ball milling) is preferable. While in the illustrated embodiment, heating of the Sb₂O₃ and SnO₂ powders was conducted at ˜1,100° C. for ˜2 hrs., heating of such intimately mixed powders may be accomplished at lower temperatures, e.g., as low as ˜700° C. However, the heating temperature should be selected to control loss of oxygen and result in a desired density;

of the different borosilicate glass frits studied, Frit 2 (glass Frit 2 (no ZnO, greater BaO content than Frit 1) is considered superior to Frit 1 for two reasons: (1) resistor composites made with Frit 2 exhibited a broader resistivity range than those made with Frit 1; and (2) Frit 2 appears to prohibit (or at least inhibit) growth of the SnO₂ particles in the glass matrix. Because grain growth can be highly sensitive to cooling and heating rates, as well as the dwell times and temperatures, processing utilizing Frit 2 is expected to be more robust than with Frit 1;

glass frits containing alkali metal oxide(s) (e.g., NaO and/or KO) should be avoided because presence of the latter results in lowered viscosity of the glass and reduced processing temperatures, hence a strong influence on the electrical properties and TCR of the resistors;

in the event cylindrical-shaped pellets (as opposed to disk-shaped pellets) are desired to be formed, the former may be fabricated by means of an extrusion process, but at least one binder and/or plasticizer may be required to be added to the Sb-doped SnO₂/glass powder mixture to provide a “green” body for facilitating processing;

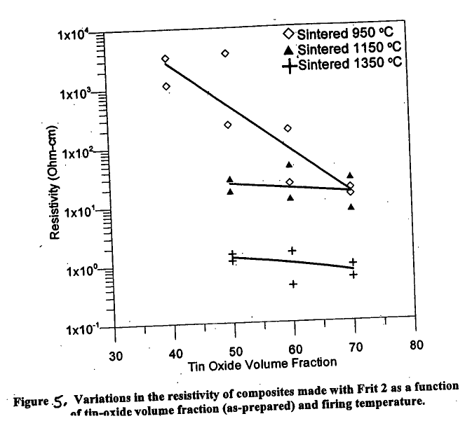

using Frit 2 and either of the Sb-doped SnO₂ powders mixed in varying volume ratios and fired at various sintering temperatures and intervals from about ˜30 to ˜60 min, it is possible to achieve resistivities ranging over 4 orders of magnitude by appropriate selection of the vol. % SnO₂ and/or firing temperature. Adverting to FIG. 5, which is a graph illustrating variations in resistivity of the Sb-doped SnO₂/glass composites made with Frit 2 as a function of vol. % SnO₂ (as prepared) and firing temperature. As is evident from the figure, samples fired at 1,150° C. and 1,350° C. exhibited a relatively small variation (i.e., <1 order of magnitude) with vol. % SnO₂. While the samples fired at 950° C. exhibited a relatively wide range of resistivities, the range is not wide enough to yield resistors >50 KΩ using traditional resistor dimensions. Samples fired at 950° C. also exhibit a large resistance variation for a given composition, tend to be very porous, thus unduly humidity sensitive, and have higher TCR's. Thus, resistors made by firing at ˜950° C. may require longer firing intervals than resistors made at higher firing temperatures, in order to reduce porosity to acceptable levels;

possible strategies for achieving dense sintered compacts with wide range of resistivity include: (1) incorporating a third, high resistivity powder phase (e.g., Al₂O₃ powder) into the powder mixture; and (2) utilizing a SnO₂/glass system providing a more complex microstructure, e.g., where “particles” comprised of Sb-doped SnO₂ particles in a glass matrix are dispersed in another glass matrix.

Thus, the present invention advantageously provides improved SnO₂-based ceramic resistors and manufacturing methodology therefore, which resistors can be readily and cost-effectively fabricated utilizing conventional materials processing techniques. Sb-doped SnO₂/glass matrix ceramic resistors can be fabricated according to the inventive methodology with resistance values varying over 4 orders of magnitude and with improved TCR performance. While the inventive resistors are of particular utility in the manufacture of surge protection devices, their use is not so limited and they find application in all manner of electric and electronic devices.

In the previous description, numerous specific details are set forth, such as specific materials, structures, manufacturing processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present invention. It is to be understood that the present invention is capable of use in various other combinations and environments and is susceptible of changes and/or modifications within the scope of the inventive concept as expressed herein.

What is claimed is:

1. A method of manufacturing a tin oxide-based bulk ceramic resistor, comprising steps of:
(a) forming a first powder comprised of an antimony-doped tin oxide material;
(b) providing a second powder comprised of a vitreous glass frit;
(c) forming a third, mixed powder by mixing together preselected amounts of said first and second powders;
(d) forming said third, mixed powder into a solid body of preselected shape and dimensions; and
(e) treating said body at a preselected elevated temperature for a preselected interval.

2. The method according to claim 1, wherein:
step (a) comprises forming said first powder by a process comprising mixing together preselected amounts of a tin oxide powder and an antimony oxide powder and treating the resultant mixture at a preselected elevated temperature for a preselected interval.

3. The method according to claim 2, wherein:
step (a) comprises dry ball milling said preselected amounts of said tin oxide and antimony oxide powders.

4. The method according to claim 2, wherein:
step (a) comprises mixing SnO₂ and Sb₂O₃ powders in about 95:5 ratio by weight.

5. The method according to claim 2, wherein:
step (a) comprises mixing SnO₂ and Sb₂O₅ powders in about 94.5:5.5 ratio by weight.

6. The method according to claim 2, wherein:
step (a) comprises heating the resultant mixture at a temperature of about 1,100° C. for about 2 hrs.

7. The method according to claim 1, wherein:
step (b) comprises providing said second powder as a vitreous borosilicate glass frit comprising SiO₂, B₂O₃, BaO, and Al₂O₃.

8. The method according to claim 7, wherein:
step (b) comprises dry ball milling said glass frit for an interval sufficient to enable the resultant second powder to pass through a 35 mesh screen prior to use in step (c).

9. The method according to claim 1, wherein:
step (c) comprises forming said third, mixed powder by steps including wet ball milling a mixture comprised of preselected volumes of said first and second powders to form a slurry, drying the slurry to remove the liquid vehicle therefrom and form a cake, and crushing and screening the cake.

10. The method according to claim 9, wherein:
step (c) comprises wet balling said mixture of said first and second powders in water to form an aqueous slurry.

11. The method according to claim 10, wherein:
step (c) comprises drying said slurry at 70° C. for an interval sufficient to evaporate said water and form said cake, and crushing and screening said cake to form said third, mixed powder with a particle size <425 μm.

12. The method according to claim 1, wherein:
step (d) comprises forming said third, mixed powder into a flat disk or cylindrical pellet of said preselected dimensions.

13. The method according to claim 12, wherein:
step (d) comprises uniaxially pressing said third, mixed powder in a die.

14. The method according to claim 12, wherein:
step (d) comprises extruding said third, mixed powder.

15. The method according to claim 14, wherein:
step (d) further comprises incorporating at least one binder and/or plasticizer in said third, mixed powder.

16. The method according to claim 1, wherein:
step (e) comprises sintering said body at a temperature in the range from about 950 to about 1350° C. for an interval ranging from about 30 to about 60 min.

17. The method according to claim 1, further comprising a step of:
(f) forming at least a pair of electrical contacts to said body.

18. The method according to claim 1, wherein:
step (c) comprises mixing together preselected amounts of said first and second powders to form a resistor having a resistance in the range from about 3 Ω to about 50 kΩ and a temperature coefficient of resistance (TCR) in the range from about −450 to about −4,200 ppm.

19. A bulk ceramic resistor manufactured according to the method of claim 18.

20. A bulk ceramic resistor manufactured according to the method of claim 1.

21. A bulk ceramic resistor comprising a body of an antimony-doped tin oxide material dispersed in a sintered vitreous glass matrix.

22. The resistor as in claim 21, wherein said body is formed by sintering a mixture of antimony-doped tin oxide and vitreous glass powders.

23. The resistor as in claim 22, wherein said antimony-doped tin oxide powder comprises the product of firing a mixture of SnO₂ and Sb₂O₃ or Sb₂O₅ powders.

24. The resistor as in claim 23, wherein said mixture comprises SnO₂ and Sb₂O₃ powders mixed in a ratio of about 95:5 by weight.

25. The resistor as in claim 23, wherein said mixture comprises SnO₂ and Sb₂O₅ powders mixed in a ratio of about 94.5:5.5 by weight.

26. The resistor as in claim 22, wherein said sintered glass matrix comprises a vitreous borosilicate glass.

27. The resistor as in claim 21, having a resistance in the range from about 3 Ω to about 50 kΩ and a temperature coefficient of resistance (TCR) in the range from about −450 to about −4,200 ppm.

28. The resistor as in claim 21, further comprising at least a pair of electrical contacts affixed to said body.

29. The resistor as in claim 28, wherein said electrical contacts comprise silver (Ag).
